(19) United States
(12) Patent Application Publication
(10) Pub. No.: US 2025/0103474 A1
(43) Pub. Date: Mar. 27, 2025

(54) NETWORK EMULATOR TO TEST ONLINE COMPUTER GAME

(71) Applicant: Sony Interactive Entertainment LLC, San Mateo, CA (US)

(72) Inventors: Robby Cheverton, San Mateo, CA (US); Omar Brito, San Mateo, CA (US); Josh Young, San Mateo, CA (US)

(21) Appl. No.: 18/472,844

(22) Filed: Sep. 22, 2023

(51) Int. Cl. G06F 11/36

(52) U.S. Cl. CPC G06F 11/3698

(57) ABSTRACT

Techniques are described for testing execution of a computer game by the game developer under one or more emulated network conditions provided by a portable network emulator that can be connected to the game developer system and that can receive various emulated network settings to be imposed upon the system during test execution of the computer game.

### FIELD

The present application relates to technically inventive, non-routine solutions that are necessarily rooted in computer technology and that produce concrete technical improvements, and more specifically to network emulators to test online computer games.

### BACKGROUND

Video such as computer simulation video such as computer game video may be streamed to end user terminals over a network.

### SUMMARY

As understood herein, it is desirable to test video games intended for network delivery to end users under network streaming conditions. subjective eval after injection. For example, test case network errors may be used, such as disconnect from one or more servers, to determine if the video game has appropriate error handling provisions. Further, a tester can subjectively analyze game performance under conditions of less-than-optimal network connectivity and try to optimize game the game in response, such as by increasing packet delivery rate when network conditions degrade or slowing down the required input rate from the end user gamer.

However, as also understood herein, such testing typically requires an enterprise IT solution that lacks the portability and that can be expensive. Moreover, use of an actual large scale network for testing can confound repeatability of the test conditions.

Accordingly, a portable network emulator provides portable network emulation capabilities and server blocking simulation in non-enterprise game testing environments. The network emulator provides network traffic shaping features that can be used to assess online game performance against a variety of adverse network conditions. The emulator provides the network emulation features required to test an online game without the large scale and costly enterprise grade equipment of an office network environment, which of important technical value to game developers. The network emulator has a small form factor intended to sit on the developer's desk and be controlled via a simple touch screen interface. It's also inexpensive, costing a fraction of an enterprise system that supports the same features. The network emulator is standalone and is wrapped up in other enterprise gear.

In one aspect, an apparatus includes at least one processor assembly configured to receive input to establish at least one network condition to be emulated. The apparatus further includes at least one electrical connection for locally connecting to a network interface component (NIC). The NIC is associated with a device configured to execute a computer game. The input to the processor assembly is configured to impose the network condition to be emulated on play of the computer game to test the computer game without connecting the device to a wide area network to test the computer game against the network condition.

For example, the network condition to be emulated may include one or more of bandwidth, packet loss, jitter, latency, and loss of a server connection.

In examples, the device can include a computer game console. If desired, a display may be provided communicating with the processor assembly. In such an embodiment, the processor assembly may be configured to present on the display at least one user interface (UI) configured to receive the input to establish the network condition(s) to be emulated.

In another aspect, an apparatus includes at least one computer medium that is not a transitory signal and that in turn includes instructions executable by at least one processor assembly to receive, from at least one input device, an indication of at least one network condition to be emulated. The instructions are executable to provide, via a local communication path, the network condition to be emulated to a device configured to execute at least one application to test the application for operation under the network condition to be emulated.

In another aspect, a method, includes connecting a wide area network (WAN) port of a portable network emulator to an Internet connection assembly associated with a device configured to execute at least one application. The method also includes connecting an admin port of the portable network emulator to the Internet connection assembly, and connecting a native local area network (LAN) Ethernet port of the Internet connection assembly to the device. The method includes receiving input at the network emulator of at least one network condition to be emulated and providing the input at the network emulator to the device through the Internet connection assembly to test execution of the application under the network condition.

The details of the present disclosure, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in consistent with present principles;

FIG. 2 illustrates a combined software and hardware diagram of an example system;

FIG. 3 illustrates network emulator deployment in example flow chart format;

FIG. 4 is a perspective view of an example network emulator connected to a device to be tested;

FIG. 5 is a screen shot of an example user interface (UI) for enabling an end user game producer to set desired network conditions to be emulated;

FIG. 6 is a screen shot of an example UI for inputting server IP addresses to be blocked, for the purpose of emulating failed connections to network services;

FIG. 7 is a screen shot of an example UI displaying an error message according to FIG. 3;

FIG. 8 illustrates example logic in example flow chart format consistent with present principles;

FIG. 9 illustrates an example results UI; and

FIGS. 10 and 11 illustrate example logic in example flow chart format for using a machine learning (ML) model to aid the game developer in ascertaining whether imposed emulated network conditions result in any just noticeable differences in presentation of a computer game.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor assembly may include one or more processors.

Components included in one embodiment can be used in other embodiments in any appropriate combination. For example, any of the various components described herein and/or depicted in the Figures may be combined, interchanged, or excluded from other embodiments. “A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

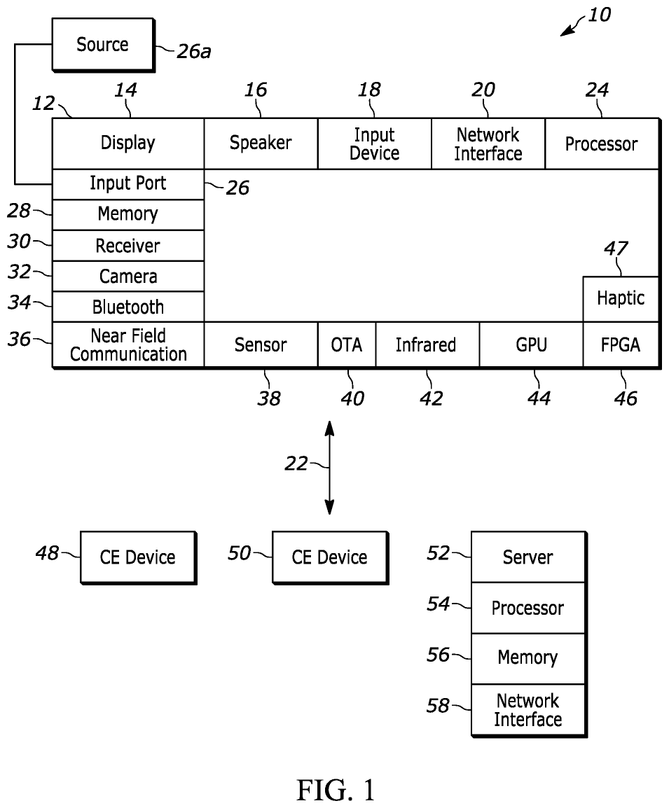

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

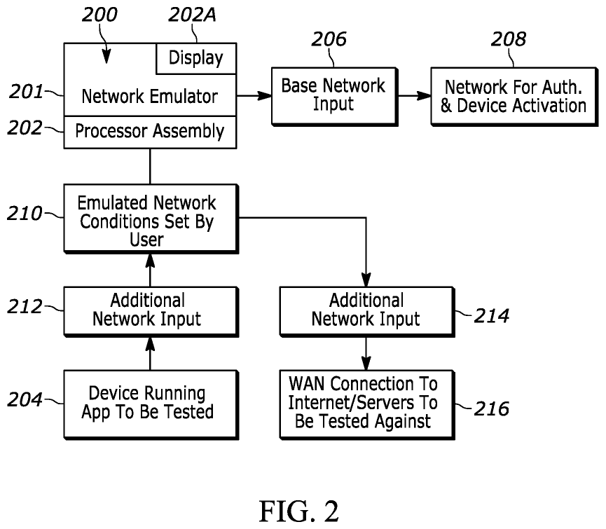

FIG. 2 illustrates a network emulator 200 with a housing 201 holding, among other components, one or more processors 202 as in a processor assembly and one or more visual and/or audio displays 202A, which may include a touchscreen display. The emulator 200 is connected locally, e.g., via hard wires, to a device 204 running an application to be tested, such as a computer game console running a computer simulation such as a computer game using emulated network conditions such as the presence of latency, jitter, packet loss, and bandwidth limitations as described herein. The emulator 200 and device 204 may contain some or all of the computer components shown in FIG. 1 as appropriate, including displays, computer storages, network interfaces, input devices, etc.

The network emulator 200 is a portable traffic intercept tool, or network tap, intended to be connected between a device such as a computer game console and the upstream internet connection. The display 202A may be a touchscreen display to provide an interface for establishing traffic shaping/bandwidth limits and various levels of network conditions including latency, packet loss, reordered packets, etc. The network emulator 200 may also run some basic IP tables functions that allow for network address blocking to specific server targets as part of an error handling test suite to evaluate online title gameplay performance during game sessions.

In this way, the network testing suite is made portable and allows for tactical deployments on the quality assurance (QA) test floor, at home with testers, or at studios with developer stakeholders. The network emulator 200 thus is not a large and costly enterprise network appliances that typically is site specific and not portable. Also, the emulator 200 provides for easily reproducible error conditions.

As shown in FIG. 2, to authenticate and activate the portable network emulator 200, the emulator 200 may be connected to base network input 206 to connect it with an enterprise network 208 upon initial installation at a game developer facility. The enterprise network 208 may be associated with the manufacturer of the emulator 200.

The network emulator 200 receives and relays to the device 204 one or more emulated network conditions 210, e.g., via the touchscreen 202A or other input device such as a mouse or keyboard. The network emulator 200 may be connected via wires to additional network input connections 212, 214, which may be respectively connected to or part of the device 204 to be tested and to a wide area network (WAN) connection to the Internet and/or servers for testing to be compared against.

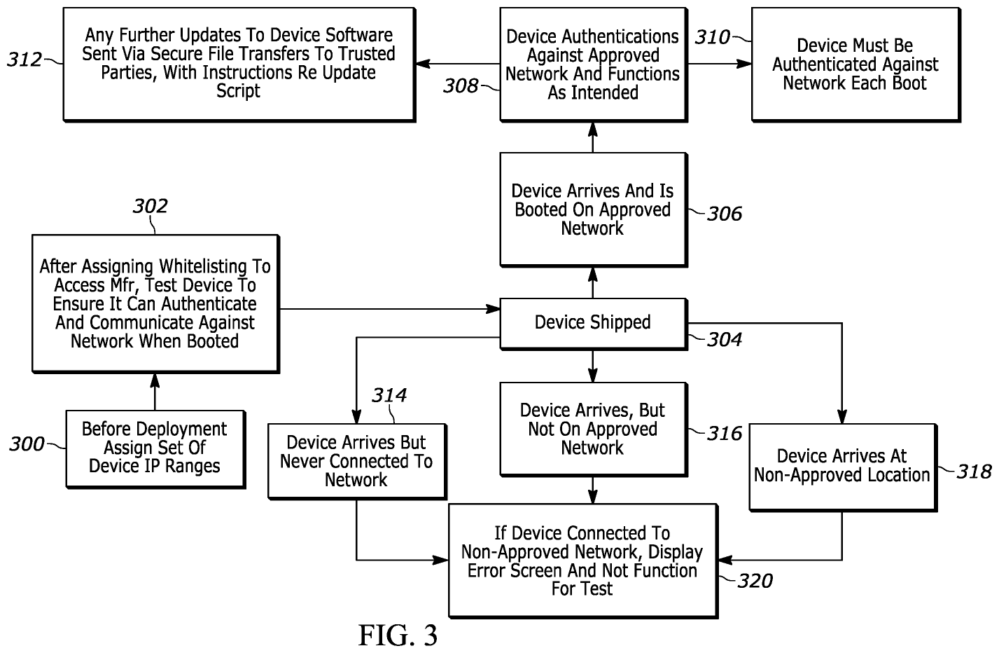

FIG. 3 illustrates network emulator installation processes. Commencing at block 300, before deployment to a game developer, a portable network emulator is assigned a set of device Internet Protocol (IP) ranges. As indicated at state 302, after assigning a whitelisting of the IP ranges to enable the portable network emulator to access the enterprise network shown at 208 in FIG. 2, the portable network emulator is tested to ensure it can authenticate itself with the enterprise network and communicate via a network during boot. The portable network emulator is then shipped to an end user game developer at state 304.

State 306 indicates what happens when the portable network emulator is received by the end user developer and is correctly booted on an approved network. At state 308 the portable network emulator is authenticated against the approved network and thereafter functions as intended to test computer games of the developer under various emulated network conditions. State 310 indicates that authentication of the portable network emulator preferably occurs after each boot. State 312 indicates that software updates to the portable network emulator are sent via secure file transfers to trusted parties with instructions and an update script.

On the other hand, states 314, 316, and 318 illustrate various errors in placing the portable network emulator on service once it is received by the end user game developer. State 314 for instance represents the case in which the portable network emulator arrives at the correct location but is never connected to any network. State 316 represents the case in which the portable network emulator arrives at the correct location but is not connected to an approved network. State 318 represents the case in which the portable network emulator does not arrive at an approved location. In each of these three cases state 320 indicates that if the device is connected to a non-approved network as may be determined from failed authentication for instance, an error screen is displayed, e.g., on the display 202A shown in FIG. 2, and the portable network emulator is disabled from further functioning.

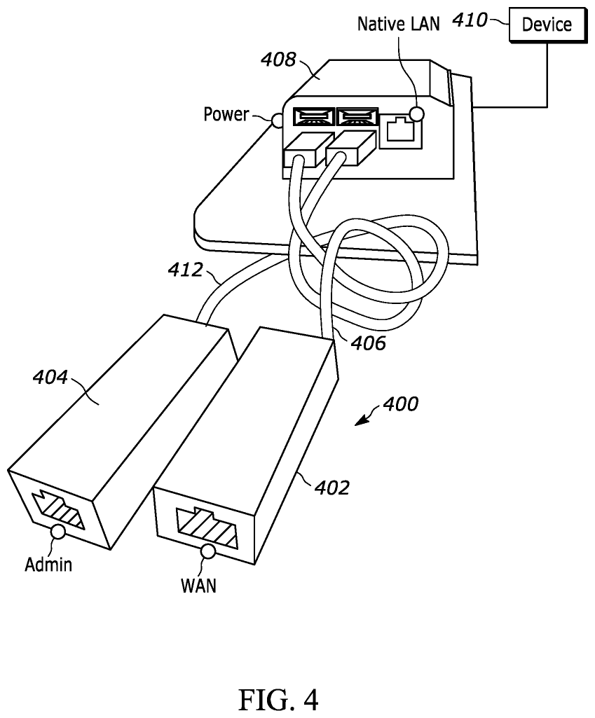

FIG. 4 illustrates an example portable network emulator 400 that includes a wide area network (WAN) port 402 and an admin port 404. The WAN port 402 is an upstream connection to a simulated server that is incorporated into the emulator while the admin port 404 is an analytics report for recording the input network conditions and game performance to maintain a data log for later review.

The WAN port 402 is connected via a wire 406 to an Internet connection assembly 408 associated with the device 410 to be tested, such as a computer game console executing a computer game. The Internet connection assembly 408 may be integral to the device 410 or may be separate from the device 410 and connected thereto by one or more electrical connectors. The Internet connection assembly 408 may be, e.g., a router or bridged virtual private network (VPN). Similarly, the admin port 404 of the portable network emulator 400 is connected via a wire 412 to the Internet connection assembly. Local wireless paths such as Bluetooth may be used in lieu of the local wired paths 406, 412.

The Internet connection assembly 408 may also include a native local area network (LAN) Ethernet port 414, which is connected to the device 410.

In this way, input may be received at the network emulator 400 of at least one network condition to be emulated and provided to the device 410 through the Internet connection assembly 408 to test execution of the application under the network condition as if the application were being received from the Internet.

As examples, the network condition to be emulated may include one or more of bandwidth, packet loss (dropped packets), jitter, latency, reordered packets, use of duplicate packets, and loss of a server connection.

Note that in connecting the portable network emulator 400 to the device 410 as shown in the example architecture of FIG. 4, a combination of IP Tables and tc-netem may be used. The software-defined network (SDN) configures dynamically to whichever dynamic host configuration protocol (DHCP) network it connects to. No pre-configuration of the network need be done. Any appropriate DHCP network can be used, such as cable, digital subscriber line (DSL), etc. Testers can simply plug the network emulator into the Internet connection assembly of the device hosting the application to be tested as a client.

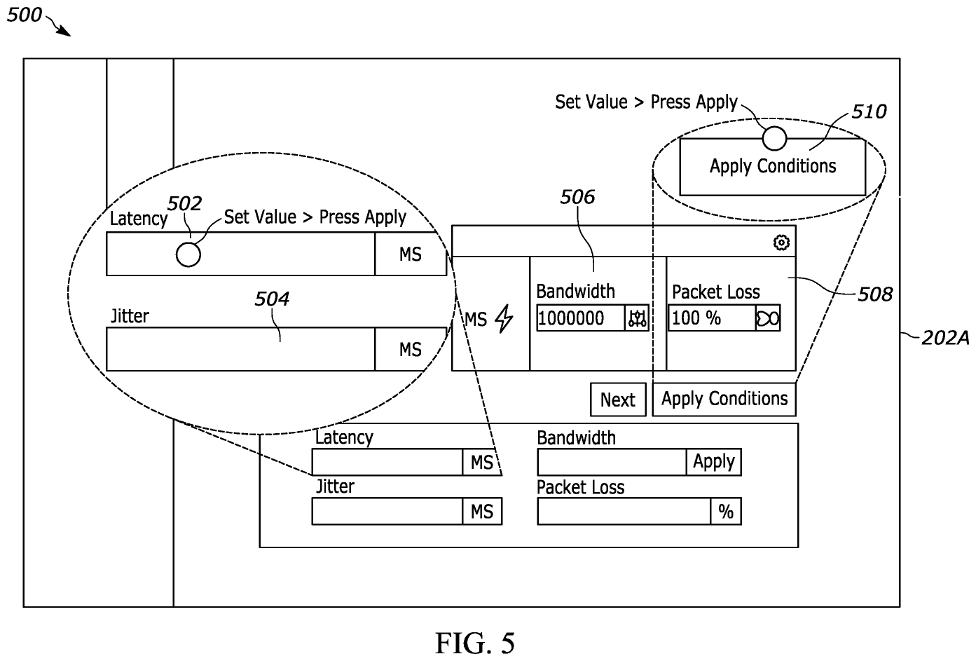

FIG. 5 illustrates a user interface (UI) 500 that may be presented on the portable network emulator, such as on the display 202A shown in FIG. 2, for receiving selection of various network conditions to be emulated. In FIG. 5, portions of the UI are enlarged for easier viewing as indicated by the dashed ovals surrounding the enlargements.

As shown, a latency selector 502 may be provided on the UI 500 to allow the game developer to set a value for emulated network latency and apply it to the application to be executed by the test device. Similarly, a jitter selector 504 may be provided on the UI 500 to allow the game developer to apply emulated jitter to the application to be executed by the test device. The jitter selector may enable the tester to specify a percentage of packets to emulate as experiencing jitter, as well as a jitter delay period for the percentage of packets on which jitter is to be imposed.

Likewise, bandwidth and packet loss selectors 506, 508 may be provided on the UI 500 to respectively allow the game developer to set values for emulated network bandwidth and packet loss and apply them to the application to be executed by the test device. Thus, a developer testing a device on a relatively large “fat pipe” network connection of an enterprise may be able to throttle the bandwidth to a smaller bandwidth typically available at an end user gamer home.

Application of the emulated network conditions set by means of the UI 500 may be done globally using an apply conditions selector 510. Note that additionally, game developers may be allowed to specify the distribution of the packets that are dropped (random or uniform).

Note further that in addition to allowing the game developer to establish emulated network conditions, scripted scenarios may be programmed into the portable network emulator to vary the network conditions to be emulated over time to assess resilience of the application being executed on the test device when loading between network nodes/functions through processes like matchmaking, NAT, gameplay etc. Automated configuration stages of different network conditions may thus be applied over time, with worsening conditions being applied as time goes on.

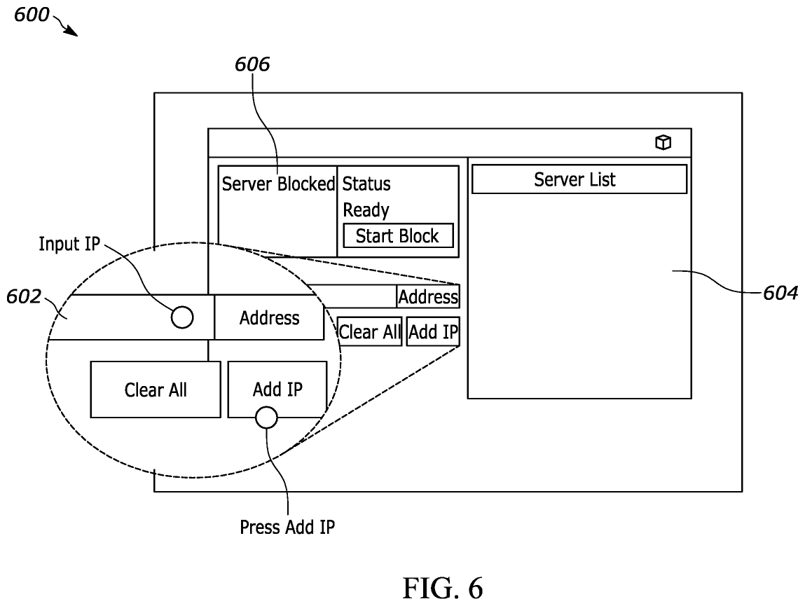

FIG. 6 illustrates a UI 600 that can be presented on the portable network emulator to test the application being executed on the test device against specific IP ranges and servers which can be emulated to have all traffic blocked to and from them. In FIG. 6, portions of the UI are enlarged for easier viewing as indicated by the dashed ovals surrounding the enlargements.

An input field 602 can be used to input network addresses of servers to emulate the servers being blocked. The blocked servers may appear on a server list 604. A start blocking selector 606 may be provided to enable the game developer to commence imposing the emulated server blockage on the application being executed by the test device. In this way, error handling of the game under dropped server conditions can be tested.

Thus, it may now be appreciated that the portable network emulator provides a handy graphical user interface for almost anybody to be able to perform network condition emulation tests practically anywhere as long as they are trusted parties and able to authenticate against the main network. The portable network emulator may include a touchscreen and a mouse and keyboard if desired. The network conditions testing currently applies the settings to both ends of the connected devices, but there may be a desire to limit conditions to only one end of the bridged connection.

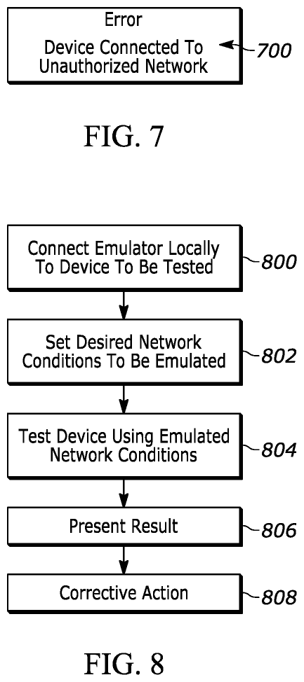

FIG. 7 illustrates an error UI 700 that may be presented on the portable network emulator as alluded to in the discussion of FIG. 3 to warn the ser that the portable network emulator is connected to an unauthorized network when such is the case.

FIG. 8 illustrates example logic consistent with disclosure herein. Commencing at state 800, the portable network emulator is connected locally to the test device, e.g., through an Internet connection assembly. The desired network condition(s) to be emulated are input into the portable network emulator at state 802 and then the application running on the test device is tested against the emulated network conditions at state 804.

Moving to state 806, results of the testing may be presented so that corrective action, if any, may be taken by the game developer at state 808 to make the application (e.g., computer game) more robust against deteriorating network conditions.

In some examples, the network condition settings of one emulator can be exported to another emulator to enable the other emulator to reproduce the test conditions easily and conveniently, which is particularly advantageous in the case of a complicated mix of network conditions. Using the emulator, tests can be automated. The emulator can run anywhere, and does not need an enterprise network and furthermore can repeat the same network errors easily.

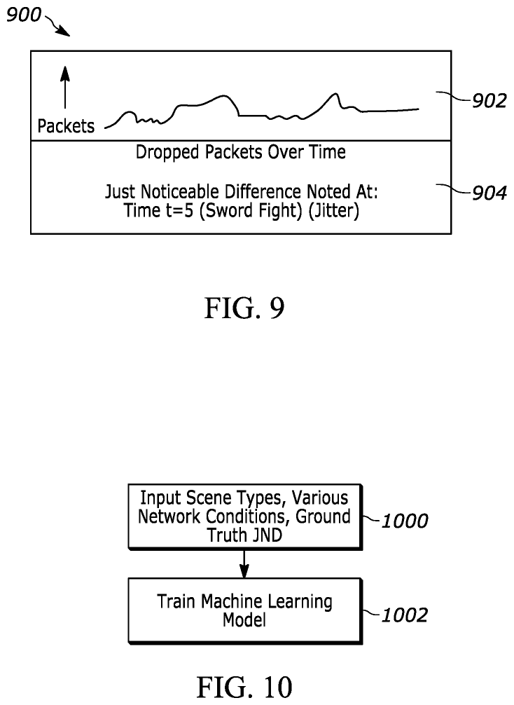

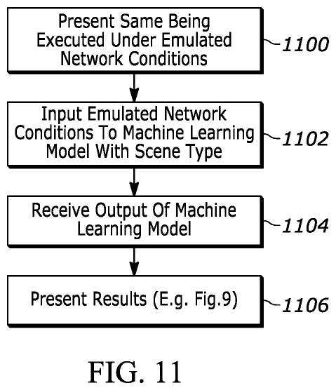

FIG. 9 illustrates a further adjunct that may be employed in some embodiments. A results UI 900 may be presented on the portable network emulator to show test results. In the non-limiting example shown, a window 902 graphically shows network traffic for visualization in real time, showing, for instance, the amount of dropped packets or just the general traffic shape. Other indicia 904 may indicate when a just noticeable difference (JND) was present during game execution along with an indication of the emulated network condition that caused it. JND is a threshold at which humans notice a degradation of quality in the video is reached. One index that may be used to indicate JND is a mean opinion score (MOS), which may be thought of as a subjective video quality metric.

FIGS. 10 and 11 illustrate an example implementation of this latter adjunctive feature. A machine learning (ML) model may be trained by inputting a training set of data to the model at state 1000 and training it at state 1002. The input set of training data may include game scene type (e.g., action, inaction, flying, driving, sword fighting, shooting, etc.) along with various network conditions and ground truth JND indication such as MOS.

Then in FIG. 11 at state 1100 during testing with emulated network conditions imposed, the game is presented so that the game developer can visually see how the game execution reacts to the network conditions. The emulated network conditions input by the game developer may also be provided to the ML model at state 1102 along with scene type of each scene of the game being executed. The output of the ML model is received at state 1104 indicating whether the emulated network conditions have produced a JND during each particular scene, and the results can be presented at state 1106 as shown in, e.g., FIG. 9.

While particular techniques are herein shown and described in detail, it is to be understood that the subject matter which is encompassed by the present application is limited only by the claims.

What is claimed is:

1. An apparatus comprising:
at least one processor assembly configured to:
receive input to establish at least one network condition to be emulated;
at least one electrical connection for locally connecting to a network interface component (NIC);
the NIC being associated with a device configured to execute a computer game, the input to the processor assembly configured to impose the network condition to be emulated on play of the computer game to test the computer game without connecting the device to a wide area network to test the computer game against the network condition.

2. The apparatus of claim 1, wherein the network condition comprises bandwidth.

3. The apparatus of claim 1, wherein the network condition comprises packet loss.

4. The apparatus of claim 1, wherein the network condition comprises jitter.

5. The apparatus of claim 1, wherein the network condition comprises latency.

6. The apparatus of claim 1, wherein the network condition comprises loss of a server connection.

7. The apparatus of claim 1, wherein the device comprises a computer game console.

8. The apparatus of claim 1, comprising at least one display communicating with the processor assembly, the processor assembly being configured to present on the display at least one user interface (UI) configured to receive the input to establish the at least one network condition to be emulated.

9. An apparatus comprising:
at least one computer medium that is not a transitory signal and that comprises instructions executable by at least one processor assembly to:
receive, from at least one input device, an indication of at least one network condition to be emulated; and
provide, via a local communication path, the network condition to be emulated to a device configured to execute at least one application to test the application for operation under the network condition to be emulated.

10. The apparatus of claim 9 wherein the device comprises a computer game console.

11. The apparatus of claim 9, wherein the application comprises a computer simulation.

12. The apparatus of claim 11, wherein the computer simulation comprises a computer game.

13. The apparatus of claim 9, wherein the network condition comprises bandwidth.

14. The apparatus of claim 9, wherein the network condition comprises packet loss.

15. The apparatus of claim 9, wherein the network condition comprises jitter.

16. The apparatus of claim 9, wherein the network condition comprises latency.

17. The apparatus of claim 9, wherein the network condition comprises loss of a server connection.

18. The apparatus of claim 9, comprising at least one display communicating with the processor assembly, the instructions being executable to present on the display at least one user interface (UI) configured to receive the input to establish the at least one network condition to be emulated.

19. A method, comprising:
connecting a wide area network (WAN) port of a portable network emulator to an Internet connection assembly associated with a device configured to execute at least one application;
connecting an admin port of the portable network emulator to the Internet connection assembly;
connecting a native local area network (LAN) Ethernet port of the Internet connection assembly to the device;
receiving input at the network emulator of at least one network condition to be emulated; and
providing the input at the network emulator to the device through the Internet connection assembly to test execution of the application under the network condition.

20. The method of claim 19, wherein the device comprises a computer game console and the application comprises a computer game.
